(19) United States
(12) Patent Application Publication
(10) Pub. No.: US 2026/0200180 A1
(43) Pub. Date: Jul. 16, 2026

(54) SYSTEM AND METHOD FOR JOINING CLEAR FLEXIBLE TUBING USING LASER WELDING

(71) Applicant: Edison Welding Institute, Inc., Columbus, OH (US)

(72) Inventors: Miranda B. Marcus, Columbus, OH (US); Jeffrey J. Boyce, Columbus, OH (US)

(21) Appl. No.: 19/018,419

(22) Filed: Jan. 13, 2025

(51) Int. Cl. B29C 65/16; B29C 65/00; B29C 65/78; B29K 701/12; B29L 23/00

(52) U.S. Cl. CPC B29C 65/1632; B29C 65/7838; B29C 66/63; B29K 2701/12; B29K 2995/0026; B29L 2023/005

(57) ABSTRACT

A method for welding clear flexible tubing, comprising inserting or otherwise contacting a first section of clear flexible tubing into or with a second section of clear flexible tubing to create an assembly; placing the assembly in a reflective fixture, wherein the reflective fixture includes first and second reflective surfaces set at a predetermined angle relative to one another; using a laser to irradiate the assembly where the first section of tubing is inserted into or otherwise contacts the second section of tubing, wherein irradiating the assembly at this location creates a weld joint between the tubing sections; and removing the welded assembly from the reflective fixture.

### BACKGROUND

The disclosed technology relates in general to industrial processes for joining materials, and more specifically to a system and method for joining segments of clear flexible tubing to one another using laser welding.

Clear flexible tubing is commonly used in medical and surgical applications and with a wide variety of medical and surgical devices. This tubing may be made from a variety of materials, including polyvinyl chloride (PVC), fluoropolymers, and thermoplastic silicones. Because no viable welding technique currently exists, sections of such tubing are typically joined together or to an attachment using solvent bonding or adhesives. However, solvent bonding and adhesives are not ideal for medical and surgical applications due to the potential for contamination created by the use of solvents and adhesives. Solvent bonding and adhesive-based joining techniques also require a consumable that adds expense to the joining process. Furthermore, while solvent bonding can be used for PVC tubing, it is not viable for fluoropolymers or thermoplastic silicones. Additionally, both fluoropolymers and thermoplastic silicones are difficult to adhesively bond due to the low surface energy of these materials, which is a quality that makes these materials desirable for medical applications. Accordingly, there is an ongoing need for a system and method for joining or attaching sections of PVC, fluoropolymer and thermoplastic silicone tubing that does not require the use of solvents or adhesives.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One embodiment of the disclosed technology provides a first method for welding clear flexible tubing, comprising inserting or otherwise contacting a first section of clear flexible tubing into or with a second section of clear flexible tubing to create an assembly; placing the assembly in a reflective fixture, wherein the reflective fixture includes first and second reflective surfaces set at a predetermined angle relative to one another; using a laser to irradiate the assembly where the first section of tubing is inserted into or otherwise contacts the second section of tubing, wherein irradiating the assembly at this location creates a weld joint between the tubing sections; and removing the welded assembly from the reflective fixture.

Implementations of this embodiment further comprise inserting a supportive mandrel into the first section of clear flexible tubing prior to inserting the first section of clear flexible tubing into the second section of clear flexible tubing. The supportive mandrel is removed after the welded assembly has been removed from the reflective fixture. The clear flexible tubing may be a thermoplastic polymer. The first and second reflective surfaces may be mirrored surfaces or highly polished metal surfaces. The predetermined angle between the first and second reflective surfaces may in the range of 35°-45°. The wavelength of the laser may be 2 μm, the power of the laser may be in the range of 20-25 W, and the speed of the laser may be 5 mm/s. The wavelength, angles, powers, and speed may be predetermined based on the type of tubing material and the size of tubing (e.g., ⅛ inch or other diameter(s)).

Another embodiment of the disclosed technology provides a second method for welding clear flexible tubing, comprising inserting or otherwise contacting a first section of clear flexible tubing into or with a second section of clear flexible tubing to create an assembly; placing the assembly in a reflective fixture, wherein the reflective fixture includes first and second reflective surfaces set at a predetermined angle relative to one another, and wherein the predetermined angle between the first and second reflective surfaces is in the range of 35°-45°; using a laser having a predetermined wavelength to irradiate the assembly where the first section of tubing is inserted into or otherwise contacts the second section of tubing, wherein irradiating the assembly at this location creates a weld joint between the tubing sections; and removing the welded assembly from the reflective fixture.

Implementations of this embodiment further comprise inserting a supportive mandrel into the first section of clear flexible tubing prior to inserting the first section of clear flexible tubing into the second section of clear flexible tubing. The supportive mandrel is removed after the welded assembly has been removed from the reflective fixture. The clear flexible tubing may be a thermoplastic polymer. The first and second reflective surfaces may be mirrored surfaces or highly polished metal surfaces. The power of the laser may be in the range of 20-25 W, and the speed of the laser may be 5 mm/s. The wavelength, angles, powers, and speed may be predetermined based on the type of tubing material and the size of tubing (e.g., ⅛ inch or other diameter(s)).

Still another embodiment of the disclosed technology provides a third method for joining clear flexible tubing, comprising mounting a section of clear flexible tubing on an attachment to create an assembly; placing the assembly in a reflective fixture, wherein the reflective fixture includes first and second reflective surfaces set at a predetermined angle relative to one another; using a laser to irradiate the assembly where the first section of tubing is mounted on the attachment, wherein irradiating the assembly at this location creates a weld joint between the tubing section and the attachment; and removing the welded assembly from the reflective fixture.

In various implementations of this embodiment, the clear flexible tubing is a thermoplastic polymer and the attachment is a thermoplastic polymer. The first and second reflective surfaces may be mirrored surfaces or highly polished metal surfaces. The predetermined angle between the first and second reflective surfaces may in the range of 35°-45°. The wavelength of the laser may be 2 μm, the power of the laser may be in the range of 20-25 W, and the speed of the laser may be 5 mm/s. The wavelength, angles, powers, and speed may be predetermined based on the type of tubing material and the size of tubing (e.g., ⅛ inch or other diameter(s)).

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and together with the general description given above and detailed description given below, serve to explain the principles of the disclosed subject matter, and wherein:

FIG. 1 is a front view of a tubing assembly placed in a reflective fixture for creating welds between individual sections of tubing in the tubing assembly using a laser, in accordance with an example embodiment of the disclosed technology;

FIG. 2 is a top view of the tubing assembly and reflective fixture of FIG. 1;

FIG. 3 is a front perspective view of the tubing assembly and reflective fixture of FIG. 1;

FIG. 4 depicts a weld joint created with the disclosed technology, wherein the power of the laser used to create the weld joint was 30 W and the speed of the laser was 5 mm/s, wherein the angle between the mirrored surfaces of the reflective fixture was 35°, and wherein an internal support mandrel was used;

FIG. 5 depicts a weld joint created with the disclosed technology, wherein the power of the laser used to create the weld joint was 30 W and the speed of the laser was 5 mm/s, wherein the angle between the mirrored surfaces of the reflective fixture was 45°, and wherein an internal support mandrel was used; and

FIG. 6 depicts a weld joint created with the disclosed technology, wherein the power of the laser used to create the weld joint was 20 W and the speed of the laser was 5 mm/s, wherein the angle between the mirrored surfaces of the reflective fixture was 45°, and wherein an internal support mandrel was not used.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The various embodiments and implementations disclosed and discussed herein are examples only and are provided to assist in the explanation of the apparatuses, devices, systems, and methods described herein. None of the features or components shown in the drawings or discussed below should be taken as required for any specific implementation of any of these apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The disclosed technology provides a system and method for laser welding sections of clear flexible tubing to one another or to an attachment. This type of tubing is typically used in medical or surgical applications for transferring blood, saline, drugs, or other fluids. The disclosed system and method utilizes a laser to create a weld between the parts and does not require that the parts to be rotated during the welding process. In general, the following materials are used in the disclosed system and method: (i) a first section of tubing (20); (ii) either a second section of tubing (30) or an attachment; (iii) a reflective fixture (60) that includes a base (62) to which an angled or semi-circular mirror (64) or highly polished metal (e.g., steel or copper) surface is attached; and (iv) a laser having a wavelength of 2 μm. Many polymers, such as plastics, have ideal amounts of wavelength absorption around 2 μm. Therefore, 2 μm radiation penetrates through the plastic material at an optimal distance, with the ability to be finely attenuated, resulting in localized heating of the material and the generation of welds with widths from 0.1-0.5 mm. While 2 μm is appropriate for most polymers, other wavelengths may be utilized for certain materials.

In general, the disclosed method includes the following process steps: (a) first tubing section 20 is inserted into second tubing section 30 or over an attachment to create an assembly (40) (note: an optional supportive mandrel may be inserted into the first tubing section); (b) assembly 40 is placed into reflective fixture 60; (c) for a predetermined period of time and at a predetermined distance from the materials, the 2 μm laser is passed across the region of assembly 40 where welding of the materials is desired to create a weld joint (50); and (d) assembly 40 is removed from fixture 60. If used, the mandrel is removed from tubing. Regarding this process, first tubing section 20 will have an outer diameter which is equal to the inner diameter of second tubing section 30, or second tubing section 30 will be thin and flexible enough to stretch over first tubing section 20, such that there is intimate contact between the outer diameter of first tubing section 20 and the inner diameter of second tubing section 30. Both tubing sections should be made from the same thermoplastic polymers or thermoplastic polymers that are compatible with one another. When the process is used to join a tubing section to an attachment, tubing section and the attachment should also be made from the same thermoplastic polymers or thermoplastic polymers that are compatible with one another. The tubing should fit tightly onto the attachment. In other implementations, the tubing sections are butted against one another rather than one section being inserted into the other (e.g., butt joints).

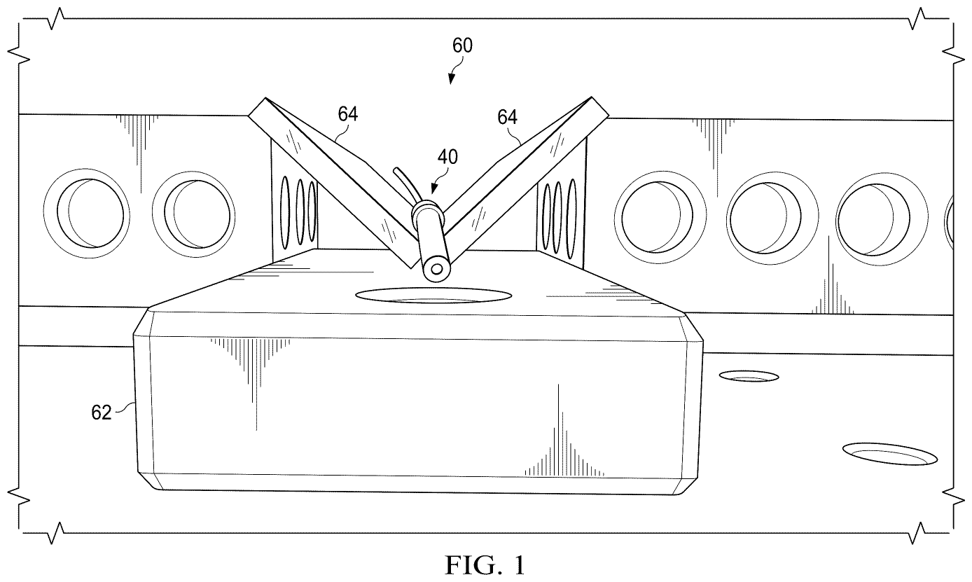

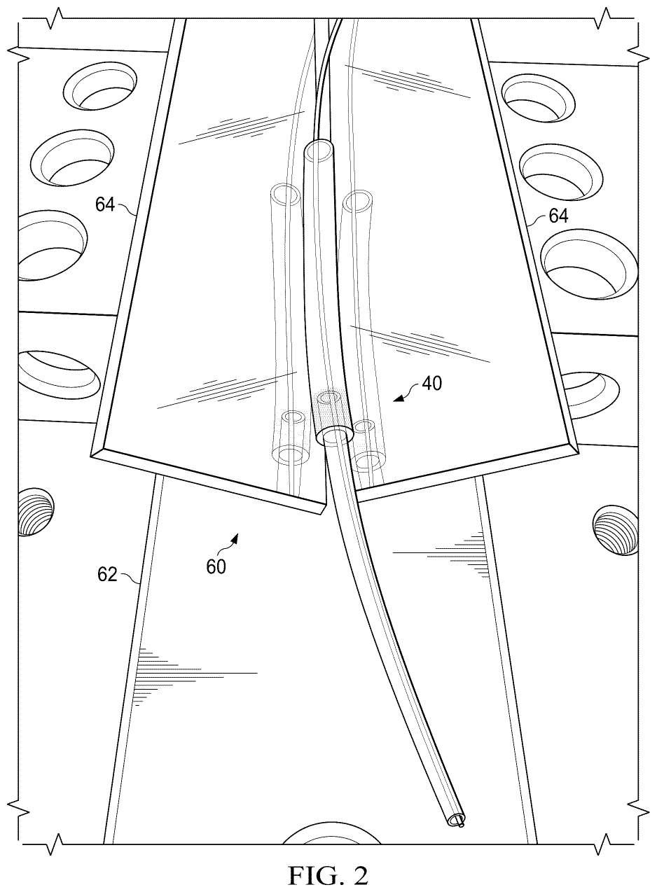

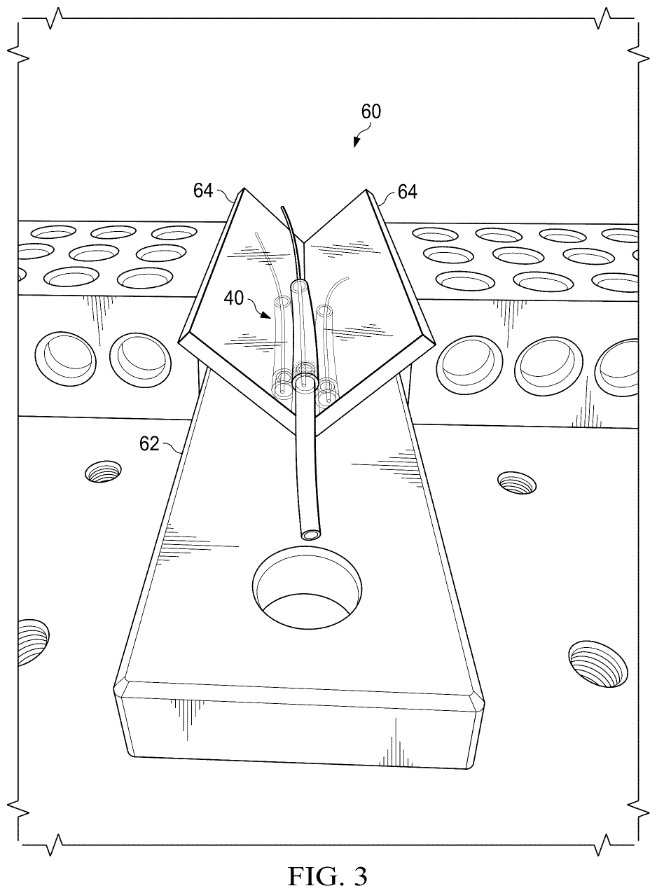

After the tubing sections are connected to one another to form the described assembly, the assembly is placed in reflective fixture 60. As shown in the Figures, reflective fixture 30 may include a mirrored surface configured as an upward facing V (see FIGS. 1-3). For a predetermined period of time and at a predetermined distance from the materials, the 2 μm laser is passed across the region of the assembly where welding of the materials is desired to create the weld joint. The energy from the 2 μm laser is partially absorbed by the polymer of the tubing, which allows for welding to occur without including a colorant in the tubing. The laser reflects off mirrored or polished surface 64 so that the full circumference of joint 50 is welded without rotating assembly 40. The wavelength, angles, powers, and speed may be predetermined based on the type of tubing material and the size of tubing (e.g., ⅛ inch or other diameter(s)).

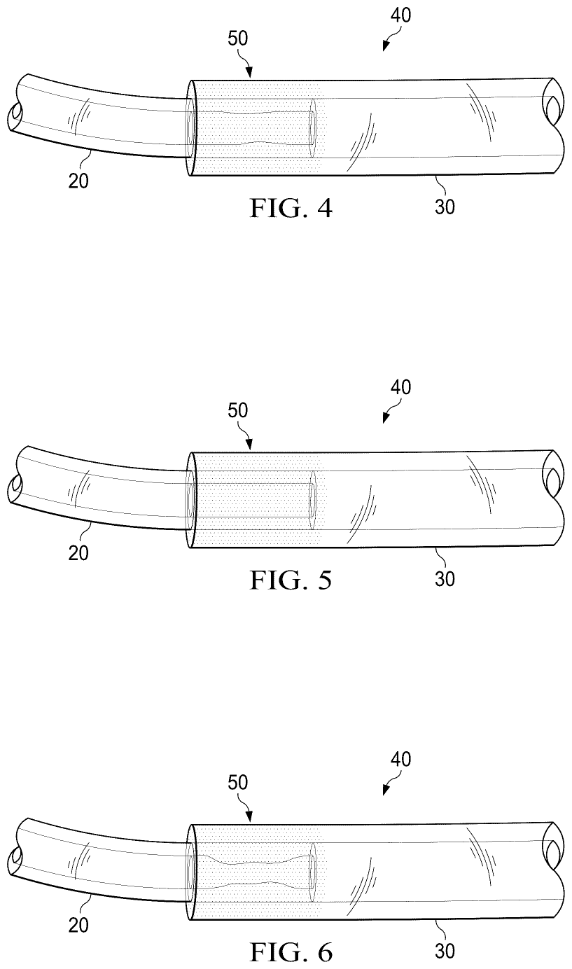

FIGS. 4-6 depict weld joints created with the disclosed system and method. FIG. 4 depicts a weld joint created with the disclosed technology, wherein the power of the laser used to create the weld joint was 30 W and the speed of the laser was 5 mm/s, wherein the angle between the mirrored surfaces of the reflective fixture was 35°, and wherein an internal support mandrel was used. FIG. 5 depicts a weld joint created with the disclosed technology, wherein the power of the laser used to create the weld joint was 30 W and the speed of the laser was 5 mm/s, wherein the angle between the mirrored surfaces of the reflective fixture was 45°, and wherein an internal support mandrel was used. FIG. 6 depicts a weld joint created with the disclosed technology, wherein the power of the laser used to create the weld joint was 20 W and the speed of the laser was 5 mm/s, wherein the angle between the mirrored surfaces of the reflective fixture was 45°, and wherein an internal support mandrel was not used.

TABLE 1, below, provides results of mechanical testing of weld joints created with the disclosed system and method. In all cases, assembly 40 ultimately failed in first tubing section 20 near weld joint 50. The tensile strength of first tubing section 20 was measured as 66 lbs. The leak pressure of assembly 40 without welding was measured to be 40 psi. The leak pressure of assembly 40 after laser welding was a minimum of 100 psi in all cases.

TABLE 1
Maximum Tensile Load of Preliminary Tube Welding Tests.

| | | Mirror | Internal | Max Tensile |
|---|---|---|---|---|
| Power (W) | Speed (mm/s) | Angle | Support | Load (lb) |
| 35 | 5 | 35° | present | 44 |
| 30 | 5 | 35° | present | 46 |
| 25 | 5 | 35° | present | 49 |
| 35 | 5 | 45° | present | 50 |
| 30 | 5 | 45° | present | 48 |
| 25 | 5 | 45° | present | 51 |
| 30 | 5 | 45° | not present | 49 |
| 20 | 5 | 45° | not present | 57 |

Advantages of the disclosed technology include the following aspects and features: (i) the tubing does not need to be rotated during the joining process; (ii) the described system includes a fixture that is structurally simple, easy to implement, and that allows for high production speed; (iii) no external pressure required or applied; (iv) support inside the tubing may be used, but is not required; (v) no consumables are used or required; and (vi) no colorant additive is required in either section of tubing.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differ from or contradict this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For one of ordinary skill in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A method for welding clear flexible tubing, comprising:
(a) inserting or otherwise contacting a first section of clear flexible tubing into or with a second section of clear flexible tubing to create an assembly;
(b) placing the assembly in a reflective fixture, wherein the reflective fixture includes first and second reflective surfaces set at a predetermined angle relative to one another;
(c) using a laser to irradiate the assembly where the first section of tubing is inserted into the second section of tubing, wherein irradiating the assembly at this location creates a weld joint between the tubing sections; and
(d) removing the welded assembly from the reflective fixture.

2. The method of claim 1, further comprising inserting a supportive mandrel into the first section of clear flexible tubing prior to inserting or otherwise contacting the first section of clear flexible tubing into or with the second section of clear flexible tubing.

3. The method of claim 2, further comprising removing the supportive mandrel after the welded assembly has been removed from the reflective fixture.

4. The method of claim 1, wherein the clear flexible tubing is a thermoplastic polymer.

5. The method of claim 1, wherein the first and second reflective surfaces are mirrored surfaces or highly polished metal surfaces.

6. The method of claim 1, wherein the predetermined angle between the first and second reflective surfaces is in the range of 35°-45°.

7. The method of claim 1, wherein the wavelength of the laser is about 2 μm.

8. The method of claim 1, wherein the power of the laser is in the range of 20-25 W.

9. The method of claim 1, wherein the speed of the laser is at least 5 mm/s.

10. A method for welding clear flexible tubing, comprising:
(a) inserting or otherwise contacting a first section of clear flexible tubing into or with a second section of clear flexible tubing to create an assembly;
(b) placing the assembly in a reflective fixture, wherein the reflective fixture includes first and second reflective surfaces set at a predetermined angle relative to one another, and wherein the predetermined angle between the first and second reflective surfaces is in the range of 35°-45°;
(c) using a laser having a predetermined wavelength to irradiate the assembly where the first section of tubing is inserted into or otherwise contacts the second section of tubing, wherein irradiating the assembly at this location creates a weld joint between the tubing sections; and
(d) removing the welded assembly from the reflective fixture.

11. The method of claim 10, further comprising inserting a supportive mandrel into the first section of clear flexible tubing prior to inserting or otherwise contacting the first section of clear flexible tubing into or with the second section of clear flexible tubing.

12. The method of claim 11, further comprising removing the supportive mandrel after the welded assembly has been removed from the reflective fixture.

13. The method of claim 10, wherein the clear flexible tubing is a thermoplastic polymer, and wherein the first and second reflective surfaces are mirrored surfaces or highly polished metal surfaces.

14. The method of claim 10, wherein the power of the laser is in the range of 20-25 W, and wherein the speed of the laser is at least 5 mm/s.

15. A method for joining clear flexible tubing, comprising:
(a) mounting a section of clear flexible tubing on an attachment to create an assembly;
(b) placing the assembly in a reflective fixture, wherein the reflective fixture includes first and second reflective surfaces set at a predetermined angle relative to one another;
(c) using a laser to irradiate the assembly where the first section of tubing is mounted on the attachment, wherein irradiating the assembly at this location creates a weld joint between the tubing section and the attachment; and
(d) removing the welded assembly from the reflective fixture.

16. The method of claim 15, wherein the clear flexible tubing is a thermoplastic polymer and wherein the attachment is a thermoplastic polymer.

17. The method of claim 15, wherein the first and second reflective surfaces are mirrored surfaces or highly polished metal surfaces.

18. The method of claim 15, wherein the predetermined angle between the first and second reflective surfaces is in the range of 35°-45°.

19. The method of claim 15, wherein the wavelength of the laser is about 2 μm.

20. The method of claim 15, wherein the power of the laser is in the range of 20-25 W, and wherein the speed of the laser is at least 5 mm/s.
